(19) United States
(12) Patent Application Publication
(10) Pub. No.: US 2025/0153872 A1
(43) Pub. Date: May 15, 2025

(54) DRONE STATION

(71) Applicant: ARGOSDYNE CO., LTD., Yonginsi, Gyeonggi-do (KR)

(72) Inventors: Seung Ho JEONG, Seongnam-si, Gyeonggi-do (KR); Seung Hyun JUNG, Seongnam-si, Gyeonggi-do (KR)

(21) Appl. No.: 18/576,267

(22) PCT Filed: Nov. 29, 2021
(86) PCT No.: PCT/KR2021/017689

§ 371 Date: Aug. 13, 2024

(30) Foreign Application Priority Data
Jul. 5, 2021 (KR) 10-2021-0087690

(51) Int. Cl. B64U 80/25; B64U 80/70

(52) U.S. Cl. CPC B64U 80/25; B64U 80/70

(57) ABSTRACT

A drone station according to an embodiment of the present invention may comprise: a station main body (10) having, mounted thereon, a charging device (20) allowing a drone to land thereon so as to be charged with drone power; a cover (30) provided at the station main body (10) so as to open/close the charging device (20) while rotating around an axle (12); and a window panel (34) provided in the cover (30), and made of a nonconductor material to transmit a GPS signal therethrough.

### TECHNICAL FIELD

The present disclosure relates to a drone station capable of allowing a drone to land thereon and takeoff therefrom and of charging the drone with power in a landing state.

### BACKGROUND ART

In general, a drone may include a main body, a motor, a rotating blade, a battery, and a control device. Further, the drone may be provided with a GPS signal receiver.

The drone may have various purposes such as agricultural, industrial, military, and the like. Regardless of the purpose, an area on which the drone lands and an area in which the drone performs actual work may be physically different from each other.

That is, the drone has to move in order to perform the purpose of use. In this case, after receiving the GPS signal and recognizing the position thereof based on the signal, the drone should move to the designated position or along the designated path.

A drone station may be an apparatus or a structure which the drone lands on or take off from. In a state in which the drone lands on the drone station, a battery of the drone may be replaced or may re-charged, and the drone may be subjected to maintenance work for other purposes.

A known drone station has a structure with an open top. However, the drone station having this structure is affected by external factors such as wind, rainwater, etc. When the drone station is affected by the external factors, a failure of the drone station may easily occur, and charging of the drone may not be smoothly performed due to a poor contact of a power terminal.

In addition, after the battery of the drone is charged at the drone station, the drone receives a GPS signal and recognizes the position thereof based on the signal for re-flight. Generally, a time taken for recognizing the GPS signal may be approximately several seconds to several minutes.

Therefore, for re-flight of the drone, it is necessary to reduce an initialization time.

### DISCLOSURE

### Technical Purpose

Therefore, a purpose of the present disclosure is to provide a drone station capable of allowing the drone to be recharged or subjected to maintenance work more safely so that the drone is protected from wind and rain, and of allowing the drone to recognize its location more quickly for re-flight, thereby significantly reducing a work processing speed.

### Technical Solution

To achieve the technical purpose, a drone station according to an embodiment of the present disclosure comprises: a station body 10 having a charging device 20 mounted thereon, wherein a drone lands on the charging device 20 configured to charge a battery of the drone; a cover 30 including a frame 32 having a grid structure, wherein the cover has a fan shape in a side view, and is installed at the station body 10 and pivots around an axle 12 to open or close the charging device 20; and a window panel 34 installed in a grid-shaped space of the frame 32, and made of a nonconductive material such that a GPS signal transmits the window panel.

In one embodiment of the drone station, the cover 30 includes both covers respectively disposed at both opposing sides of the station body 10, wherein the both covers pivot around both axles 12, respectively to be brought into an opened or closed state.

In one embodiment of the drone station, the drone station further comprises a locking device 40 configured to maintain the closed state in which the both covers 30 are in contact with each other.

In one embodiment of the drone station, the drone station further comprises a sub-cover 50 formed in a fan shape in a side view, wherein the sub-cover 50 is disposed inwardly of the cover 30, and pivots about the axle 12 to be brought into an opened or closed state.

In one embodiment of the drone station, the window panel 34 is an acrylic panel or a glass panel.

In one embodiment of the drone station, a first rib 36 is formed at a lower edge of the cover 30, and a second rib 56 is formed at an upper edge of the sub-cover 50,

wherein when the cover 30 pivots to be brought into the closed state, the first rib 36 contacts the second rib 56 to allow the sub-cover 50 to pivot.

In one embodiment of the drone station, when the cover 30 pivots to be brought into the opened state, the cover initially pivots in a state in which the second rib 56 is seated on the first rib 36, wherein when the pivot movement of the sub-cover 50 has been completed, the first rib 36 is removed from the second rib 56 such that the cover 30 is able to pivot. Specific details of other embodiments are included in the detailed description and

### DRAWINGS

### Technical Effect

As described above, the drone station according to the embodiment of the present disclosure configured as described above, the cover may be coupled to the station body so as to be opened or closed. The cover may be closed when the charging device charges the drone in the landing state to protect the drone and the charging device from rain, wind or the like.

In addition, even when the cover of the drone station according to the embodiment of the present disclosure is in a closed state, the drone may receive the GPS signal, and thus, the drone may recognize the position thereof based on the received signal. Thus, the drone may perform a mission in a state in which the drone has recognized the position thereof, thereby significantly reducing an exit time out of the drone station.

### BRIEF DESCRIPTION OF DRAWINGS

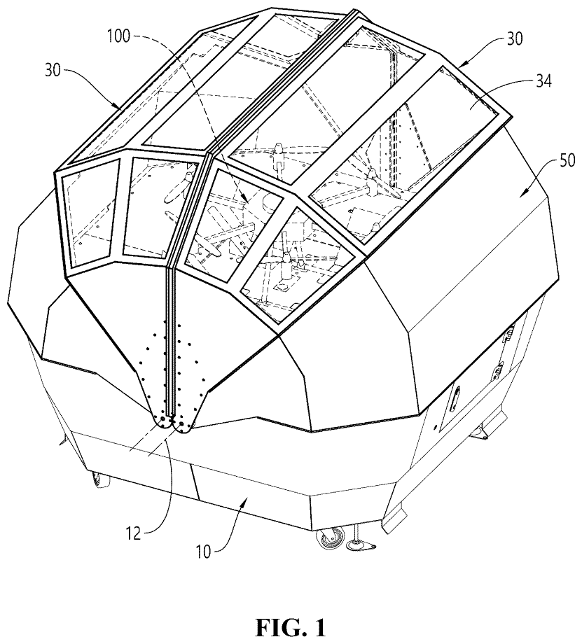

FIG. 1 is a diagram illustrating a drone station according to an embodiment of the present disclosure.

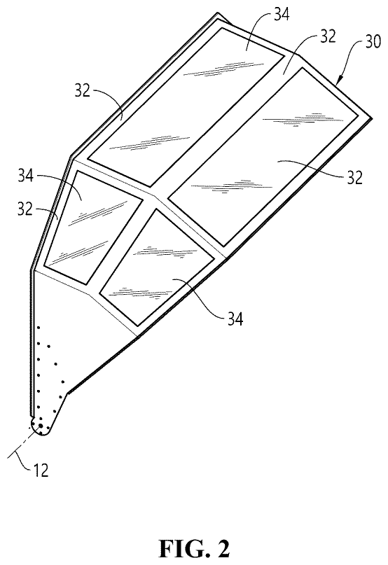

FIG. 2 is a diagram illustrating a cover in a drone station according to an embodiment of the present disclosure.

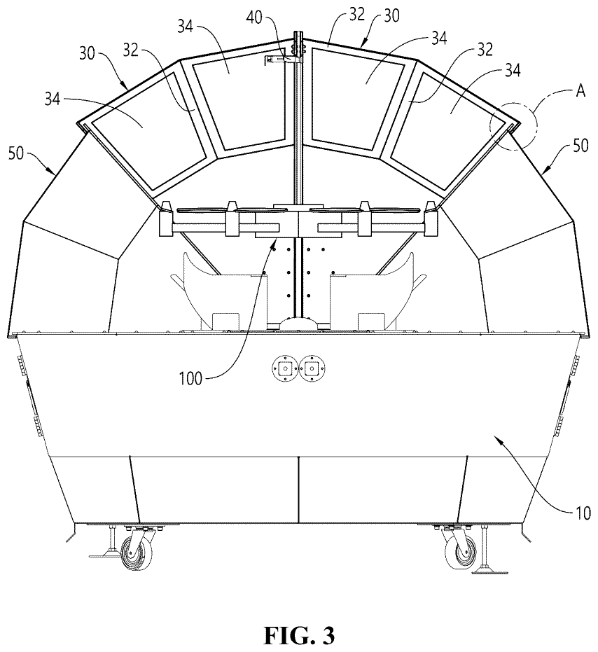

FIG. 3 is a cross-sectional view illustrating a state in which a drone is accommodated in a drone station according to an embodiment of the present disclosure.

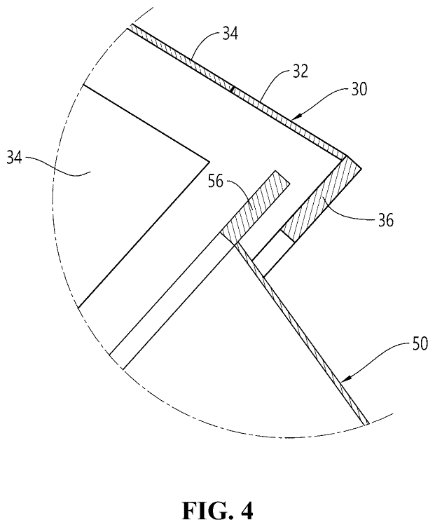

FIG. 4 is a detailed view of a portion A of FIG. 3.

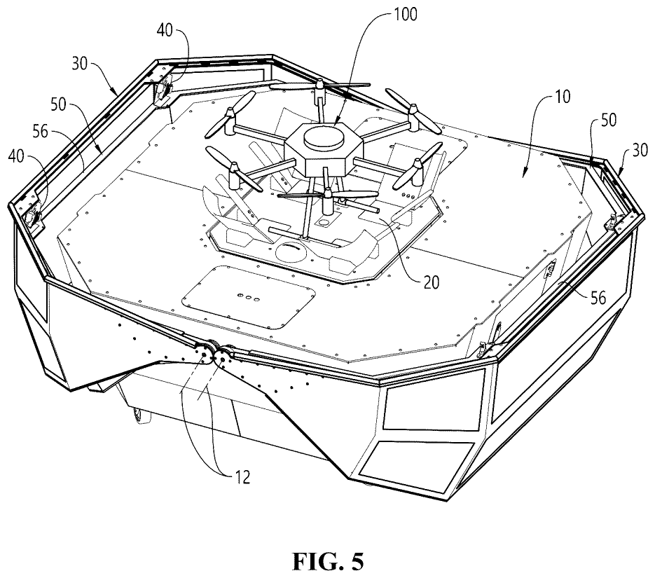

FIG. 5 is a view illustrating a state in which a cover is opened in a drone station according to an embodiment of the present disclosure.

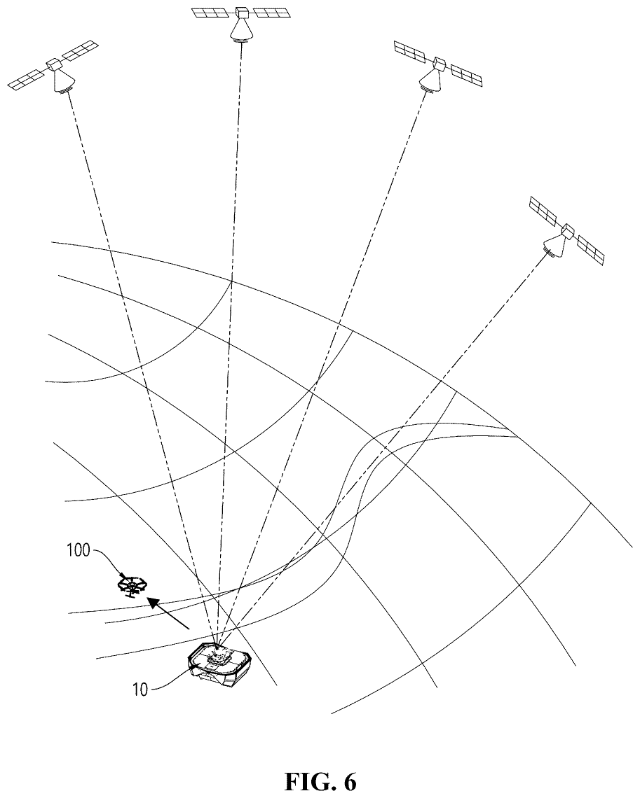

FIG. 6 is a diagram illustrating an example in which a drone exits out of a drone station according to an embodiment of the present disclosure.

### BEST MODE

The advantages and features of the present disclosure, and methods of achieving them, will be apparent with reference to the embodiments described in detail below in conjunction with the accompanying drawings.

Hereinafter, embodiments of the present disclosure will be described in detail with reference to the accompanying drawings. It should be understood that the embodiments as described below are illustrative in order to facilitate understanding of the present disclosure, and it should be understood that the present disclosure may be variously modified differently from the embodiments as described herein. However, a detailed description of known functions or components will be omitted when it may make the gist of the present disclosure rather unclear. In addition, the accompanying drawings may not be shown as an actual scale to assist in understanding of the disclosure, but rather, some components may be shown to be exaggerated in size.

Further, the terms to be described below are set in consideration of the functions of the present disclosure, and may be changed depending on the intention or customary of a manufacturer, and thus the definition thereof should be made based on the contents throughout the disclosure.

Like reference numerals refer to like elements throughout the disclosure.

Hereinafter, a drone station according to an embodiment of the present disclosure will be described with reference to FIGS. 1 to 6. FIG. 1 is a diagram illustrating a drone station according to an embodiment of the present disclosure. FIG. 2 is an illustration of a cover at a drone station in accordance with an embodiment of the present disclosure. FIG. 3 is a cross-sectional view illustrating a state in which a drone is accommodated in a drone station according to an embodiment of the present disclosure. FIG. 4 is a detailed view of a portion A of FIG. 3. FIG. 5 is a view illustrating a state in which a cover is opened in a drone station according to an embodiment of the present disclosure. FIG. 6 is a diagram illustrating an example in which a drone exits out of a drone station according to an embodiment of the present disclosure.

The drone station according to an embodiment of the present disclosure may include a station body 10, a cover 30, and a window panel 34.

The drone station has a charging device 20 mounted on a top of the station body 10. The drone lands on the charging device 20 on which the drone is charged by the charging device. When the drone 100 lands at a specific position in a designated posture, the charging device 20 may supply power to the drone 100 to charge the battery of the drone 100. The drone charging technology uses known techniques, and a detailed description thereof will be omitted.

As shown in FIGS. 1 to 5, the cover 30 may be installed in the station body 10, and may be coupled thereto via a shaft or the like and pivot about the axle 12 to open and close the charging device 20.

In addition, as shown in FIG. 2, a frame 32 may be provided in a grid structure, and the frame 32 may be made of a rigid material, for example, a metal material.

As shown in FIGS. 1 and 3, the cover 30 may be closed, and as shown in FIG. 5, the cover 30 may be opened.

The window panel 34 may be installed in the cover 30, as shown in FIGS. 1 and 2. More specifically, the window panel 34 may be disposed in a grid-shaped space of the frame 32 as shown in FIG. 2.

In addition, the window panel 34 may be made of a nonconductive material, and thus transmits a GPS signal therethrough.

As described above, in the drone station according to the embodiment of the present disclosure, the cover 30 may be coupled to the station body 10 so as to be opened or closed. The cover 30 may be closed when the charging device 20 charges the drone 100 in the landing state to protect the drone 100 and the charging device 20 from rain, wind or the like.

In addition, even when the cover 30 of the drone station according to the embodiment of the present disclosure is in a closed state, the drone 100 may receive the GPS signal, and thus, the drone 100 may recognize the position thereof based on the received signal. Thus, the drone 100 may perform a mission in a state in which the drone 100 has recognized the position thereof, thereby significantly reducing an exit time out of the drone station.

In addition, the cover 30 may be made of a rigid material to more stably support the window panel 34.

In one example, as shown in FIGS. 1, 3, and 5, the covers 30 may be respectively disposed at both opposing sides of the station body 10 so as to pivot around both axles 12, respectively, to move toward or away from each other. Accordingly, when the cover is opened or closed, a displacement of each of the covers 30 is reduced, and thus the cover 30 may be opened and closed more quickly.

In addition, as shown in FIG. 3, in the drone station according to the embodiment of the present disclosure, a locking device 40 may be installed at the cover 30. The locking device 40 may maintain the closed state in which one cover 30 is in contact with the other cover 30.

In addition, as illustrated in FIGS. 1 and 3, the drone station according to the embodiment of the present disclosure may include a sub-cover 50. The sub-cover 50 may be formed in a fan shape in a side view, may be disposed inwardly of the cover 30, and may be opened and closed while pivoting with respect to the axle 12.

As shown in FIGS. 3 and 4, the sub-cover 50 may extend so as to be connected to the cover 30. More specifically, a first rib 36 may be formed at a lower edge of the cover 30, and a second rib 56 may be formed at an upper edge of the sub-cover 50.

When the cover 30 pivots in a closing direction, the first rib 36 contacts the second rib 56 to allow the sub-cover 50 to pivot. Thus, the sub-cover 50 moves upwardly when the cover 30 is closed.

On the contrary, when the cover 30 pivots in the opening direction, the cover initially pivots in a state in which the second rib 56 seats on the first rib 36. As shown in FIG. 5, when the pivot movement of the sub-cover 50 has been completed, the first rib 36 may move away from the second rib 56 such that the cover 30 may pivot.

When the cover 30 is opened, the sub-cover 50 may pivot downwardly due to its own weight.

That is, in the drone station according to the embodiment of the present disclosure, the cover 30 is opened to entirely open a top of the station body 10 as shown in FIG. 5 to prevent the cover 30 from interfering with the drone 100 in the takeoff or landing state, and to allow a wide view angle of a drone operator to be secured.

In an example, the window panel 34 may be an acrylic panel or a glass panel. As a result, the GPS signal may easily transmit through the window panel 34, thereby allowing the drone 100 to more quickly recognize its position when the drone is initialized for re-flight.

As shown in FIG. 6, the location of the station body 10 and an area in which the drone 100 performs a mission may be different from each other. The drone 100 may receive the GPS signal from four satellites and calculate a position thereof, based on the received signal.

Thereafter, the drone 100 may fly according to a request of the drone operator and may move to a destination location or fly along a designated route, and may return to and land on the station body 10 after achieving the flight purpose.

Although the embodiments of the present disclosure have been described with reference to the accompanying drawings, the skilled person to the art appreciates that the present disclosure may be embodied in other specific forms without changing the technical spirit or essential features of the present disclosure.

Therefore, it should be understood that the embodiments described above are exemplary in all respects and are not restrictive, and the scope of the disclosure should be construed as being dependent on the claims to be described below, and all changes or modifications derived from the meaning and scope of the claims and their equivalents are intended to be included in the scope of the present disclosure.

### INDUSTRIAL APPLICABILITY

The drone station according to the embodiment of the present disclosure may be used to allow the drone to land thereon or takeoff therefrom and charge the battery of the drone.

1. A drone station comprising:
a station body 10 having a charging device 20 mounted thereon, wherein a drone lands on the charging device 20 configured to charge a battery of the drone;
a cover 30 including a frame 32 having a grid structure, wherein the cover has a fan shape in a side view, and is installed at the station body 10 and pivots around an axle 12 to open or close the charging device 20; and
a window panel 34 installed in a grid-shaped space of the frame 32, and made of a nonconductive material such that a GPS signal transmits the window panel.

2. The drone station of claim 1, wherein the cover 30 includes both covers respectively disposed at both opposing sides of the station body 10, wherein the both covers pivot around both axles 12, respectively to be brought into an opened or closed state.

3. The drone station of claim 2, further comprising a locking device 40 configured to maintain the closed state in which the both covers 30 are in contact with each other.

4. The drone station of claim 1, further comprising a sub-cover 50 formed in a fan shape in a side view, wherein the sub-cover 50 is disposed inwardly of the cover 30, and pivots about the axle 12 to be brought into an opened or closed state.

5. The drone station of claim 1, wherein the window panel 34 is an acrylic panel or a glass panel.

6. The drone station of claim 4, wherein a first rib 36 is formed at a lower edge of the cover 30, and a second rib 56 is formed at an upper edge of the sub-cover 50,
wherein when the cover 30 pivots to be brought into the closed state, the first rib 36 contacts the second rib 56 to allow the sub-cover 50 to pivot.

7. The drone station of claim 6, wherein when the cover 30 pivots to be brought into the opened state, the cover initially pivots in a state in which the second rib 56 is seated on the first rib 36,
wherein when the pivot movement of the sub-cover 50 has been completed, the first rib 36 is removed from the second rib 56 such that the cover 30 is able to pivot.
